(19) United States
(12) Patent Application Publication
(10) Pub. No.: US 2012/0011031 A1
(43) Pub. Date: Jan. 12, 2012

(54) Online Marketplace for Trading of Data Collected from Use of Products and Services

(75) Inventors: Cameron Lewis, Woodland, CA (US); Eliot Bergson, New York, NY (US)

(73) Assignee: STATZ, INC., Great Neck, NY (US)

(21) Appl. No.: 12/848,015

(22) Filed: Jul. 30, 2010

Related U.S. Application Data
(60) Provisional application No. 61/363,185, filed on Jul. 9, 2010.

(51) Int. Cl. G06Q 30/00

(52) U.S. Cl. 705/27.1; 705/26.1

(57) ABSTRACT

An online marketplace permits the trading of data collected from a plurality of end users, where the data is obtained from the use of a product or service. In one embodiment, a method includes: hosting a marketplace for trading of data provided from the end users; collecting user data from each end user, wherein the data is obtained from use by each end user of a product or a service; storing the respective user data for each respective end user; offering the user data of each end user for a trade with a customer; if the customer accepts the trade, providing the respective user data of each end user to the customer; and providing compensation to each end user based on a share of the revenue received for the trade.

### CROSS-REFERENCE TO RELATED APPLICATIONS

The present application claims the benefit of provisional U.S. Pat. App. Ser. No. 61/363,185, filed Jul. 7, 2009 and entitled “Online Marketplace for Trading of Data Collected from Use of Products and Services,” the disclosure of which application is hereby incorporated herein by reference in its entirety.

### FIELD OF THE TECHNOLOGY

At least some embodiments disclosed herein relate to online marketplaces for trading of data in general, and more particularly, but not limited to, online marketplaces for trading of data collected from the use of products and/or services by one or more persons and/or entities.

### BACKGROUND

Various objects may be embedded with sensors in order to gain an ability to communicate. Information from these sensors may be communicated on various communication networks (e.g., the Internet). For example, sensors embedded in physical objects (e.g., personal communication devices like mobile phones or other forms of consumer products like bicycles or kitchen appliances such as microwave ovens, or even business products such as farming equipment) may be linked to wired and wireless networks, for example using the Internet Protocol (IP) of the Internet.

Data collected over these networks provides large volumes of data that may be analyzed by computers. For example, precision farming equipment using wireless links to collect data from remote satellites and ground sensors may consider crop conditions and adjust the way each individual part of a field is farmed—for example, by spreading extra fertilizer on certain areas.

The sensing of a customer's buying preferences in real-time at a specific location, or knowledge of how a product or service is used may provide useful information for product and service providers. Also, manufacturing processes using a multitude of sensors can be controlled more precisely. Advances in wireless networking technology and the increasing standardization of communications protocols make it possible to collect data from the above sensors in many situations.

As communication networks link such data from various products, one or more of information, analysis, and decision-making may be improved. For example, when products are embedded with sensors, a company can track the movements of these products. Some insurance companies, for example, are offering to install location sensors in customers' cars. Thus, the price of policies may be based on how a car is driven and where it travels.

Another application using sensors to collect data is the use of sensors to track RFID (radio-frequency identification) tags placed on products moving through supply chains. Data from large numbers of sensors, deployed in infrastructure (such as roads and buildings) or to report on environmental conditions (e.g., weather), may provide increased awareness of real-time events, particularly when the sensors are used with advanced display or visualization technologies.

As another example, in retailing, some companies gather and process data from shoppers as they travel through stores. Sensor readings and videos note how long shoppers remain at individual displays and record what they ultimately buy. Also, in health care, sensors and data links permit the monitoring of a patient's behavior and symptoms in real-time.

The data collected from the various sensors discussed above may form the basis for various forms of automation and control. The collected data is analyzed and used as a basis for instructions that feed back through the network to modify processes. Closing the loop from data to automated applications can raise productivity. Some industries, such as chemical production, are installing numerous sensors to provide greater granularity to monitoring. These sensors provide data to computers, which in turn analyze them and then may send signals to adjust processes (e.g., modifying ingredient mixtures, temperatures, or pressures).

Also, networked sensors and automated feedback mechanisms can change usage patterns for scarce resources such as energy and water. For example, some utilities are deploying “smart” meters that provide residential and industrial customers with visual displays showing energy usage and the real-time costs of providing it.

### SUMMARY OF THE DESCRIPTION

Systems and methods to provide a marketplace for the trading of data collected from a plurality of end users, wherein the data is obtained from the use of a product or service, are described herein. Some embodiments are summarized in this section.

In one embodiment, a method implemented in a data processing system (e.g., on a web server hosting a website) includes: hosting a marketplace for trading of data provided from a plurality of end users; collecting respective user data from each respective end user of the plurality of end users, the respective user data comprising data obtained from use by the respective end user of at least one of a product and a service; storing the respective user data for each respective end user; offering, via the marketplace, the respective user data of each respective end user for a trade with a first customer; if the first customer accepts the trade, providing the respective user data of a first end user to the first customer; and providing compensation to the first end user based on a share of the revenue received for the trade.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a system to trade data using an online marketplace according to one embodiment.

FIG. 2 shows a system for collecting user data using sensors according to one embodiment.

FIG. 3 shows an example of a user interface used by a customer to search for selected user data in an online marketplace for potential purchase in a trade transaction according to one embodiment.

FIG. 4 shows an example of a user interface used by an end user to register data sources and upload user data to an online marketplace according to one embodiment.

FIG. 5 shows a block diagram of a data processing system which can be used in various embodiments.

FIG. 6 shows a block diagram of a user device according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, “marketplace” means a trading exchange or other data or computer system (e.g., a hosted website) that is electronically available to or accessible by buyers and/or sellers (e.g., over the Internet or by another online or networked form of access, or by wired or wireless access) for trading (e.g., purchasing or leasing of sets or groups of data). The buyers and sellers do not need to each access the marketplace at the same time or during the same session.

At least some embodiments discussed below provide a marketplace for the trading of data obtained from one or more end users of products or services. The data may be collected by the marketplace from the end users over many various forms of conventional communications networks (e.g., the Internet or a local area network). The data collected for trading may be obtained from various forms of usage of each product or service, as described further below.

In one embodiment, a web server is used to host a marketplace for the trading of data provided from a plurality of end users. User data is collected from each of the end users. The respective user data includes data obtained from the use by each respective end user of a product and/or a service. The collected user data is stored (e.g., in a database accessible by the web server). In some embodiments, the database is stored on separate computer systems accessible by the marketplace (e.g., a network cloud or distributed storage network).

The marketplace is used to offer the user data from one or more the end users for a trade with a customer (e.g., a customer accessing the marketplace over the Internet). If the customer accepts the trade (e.g., as indicated by a clicking of a mouse in a user interface to confirm a proposed transaction to purchase a one-time or periodical data report or data profile), the user data (e.g., the data of one or more end users) is provided to the customer by the marketplace (or alternatively from another computer system authorized by the marketplace to provide the data to the customer).

Compensation is provided to each end user based on a share of the revenue received from the first customer for the trade. The share of revenue provided to each end user (e.g., via the marketplace) may be based on the extent and/or type of user data provided to the customer.

In one embodiment, the user data includes data obtained from use by each respective end user of the product, and the method further includes receiving an identification of the product (e.g., the product type, the model, manufacturer or brand, the serial number, and/or other product related information) from the respective end user prior to the collecting of the respective user data, and associating the respective user data with the identification of the product. In one embodiment, the respective user data is associated with data regarding behavior of the respective end user (e.g., manners in which the product is used by the respective user).

In some embodiments, user data is collected from many users and then aggregated and stored for access by the marketplace. Data reports purchased by customers may include data collected from a number of different end users.

In another embodiment, the product is a user device comprising a communication device and a position identification unit to provide location data. The method includes receiving, from the communication device, the location data, and further associating the respective user data with the location data.

In other embodiments, data relating to usage by each respective end user of a third-party service is collected by the marketplace. The usage of the third-party service may be, for example, one or more of the following: website usage, utility service usage, credit card usage, bank account usage, and cell phone usage. The data regarding the respective end user may be collected from a plurality of third-party websites, and this data is associated with the respective user data of the particular user that has used the service. These data associations may be stored in a database accessible by the marketplace.

In one embodiment, the respective user data includes data obtained from use by the first end user of a product, and the method further includes receiving an identification of the product from the first end user; associating the respective user data of the first end user with the product; collecting data relating to usage by the first end user of a third-party service for the product; and further associating respective user data of the first end user with the data relating to usage of the third-party service. In one embodiment, the respective user data of the first end user includes data collected by one or more sensors that monitor a product used by the first end user.

In another embodiment, the method further includes providing access to a data taxonomy for customers of the marketplace. The taxonomy includes a plurality of categories (e.g., speed, temperature, average heart rate, date) corresponding to user data obtained from many end users (e.g., there could be 5-10, hundreds, or thousands or more end users that provide data to the marketplace). The categories may be related, for example, to environmental or product conditions or characteristics associated with or existing during the time of the data collection by the sensors. The user data is then made available for purchase through the marketplace to one or more online customers. In one embodiment, the plurality of categories includes at least one of personal characteristics of a person and behavioral characteristics of a person.

As an example of product usage location, a product may be used in a business, residence, or other structure or asset owned by an entity, and user data obtained for that location. User data may come from sources as diverse as manufacturing sensors, university research data and odometers mounted on bicycles (which, for example, may be transported to various locations and the use of the bicycle measured at that location).

In further embodiments, the method further includes assigning a price to a set of user data collected from end users, and presenting the price to customers visiting the marketplace when offering the user data for trade.

In other embodiments, the method further includes receiving a definition of a data level from each respective end user, the data level defining the forms of data for collection from the respective end user. The data level may indicate the extent of and type of data that the end user authorizes to be collected.

In one embodiment, a customer user interface is provided. The method further includes providing, via the marketplace, a user interface to a plurality of customers. The user interface is configured to present to each respective customer, for example, one or more of the following: a plurality of data categories for selection by the respective customer, and a menu of demographic categories for selection by the respective customer. The method further includes, after the selection by the respective customer of at least one of the data categories and of at least one of the demographic categories, providing, via the marketplace, a price for a data report for purchase by the customer.

In one embodiment, the data report includes the respective user data of the first end user, and the method further comprises receiving the revenue for the trade from the customer in exchange for the data report. In one embodiment, the method further includes providing the data report to the customer in the form of a plurality of periodic reports sent over time, and receiving the revenue in the form of a series of payments from the customer, each of the series of payments corresponding to one of the periodic reports. In one embodiment, the method further includes providing the data report to the customer, and the data report includes user data from each of the plurality of end users.

In other embodiments, the data report or other data set provided to a customer is a fixed form and fixed use report, an index or aggregation of data in a predetermined format, or a continuing stream of data. In one embodiment, the marketplace periodically sends a portion of the stream of data to the customer.

In one embodiment, a data processing system includes: (a) memory to store user data for a plurality of end users; and (b) one or more processors (e.g., a microprocessor or microcontroller, or multiple processors on a single chip) configured to: host a marketplace for trading of data provided from the plurality of end users; collect respective user data from each respective end user of the plurality of end users, the respective user data comprising data obtained from use by the respective end user of at least one of a product and a service; offer the respective user data of each respective end user for a trade with a first customer; if the first customer accepts the trade, provide the respective user data of a first end user to the first customer; and provide compensation to the first end user based on a share of the revenue received for the trade.

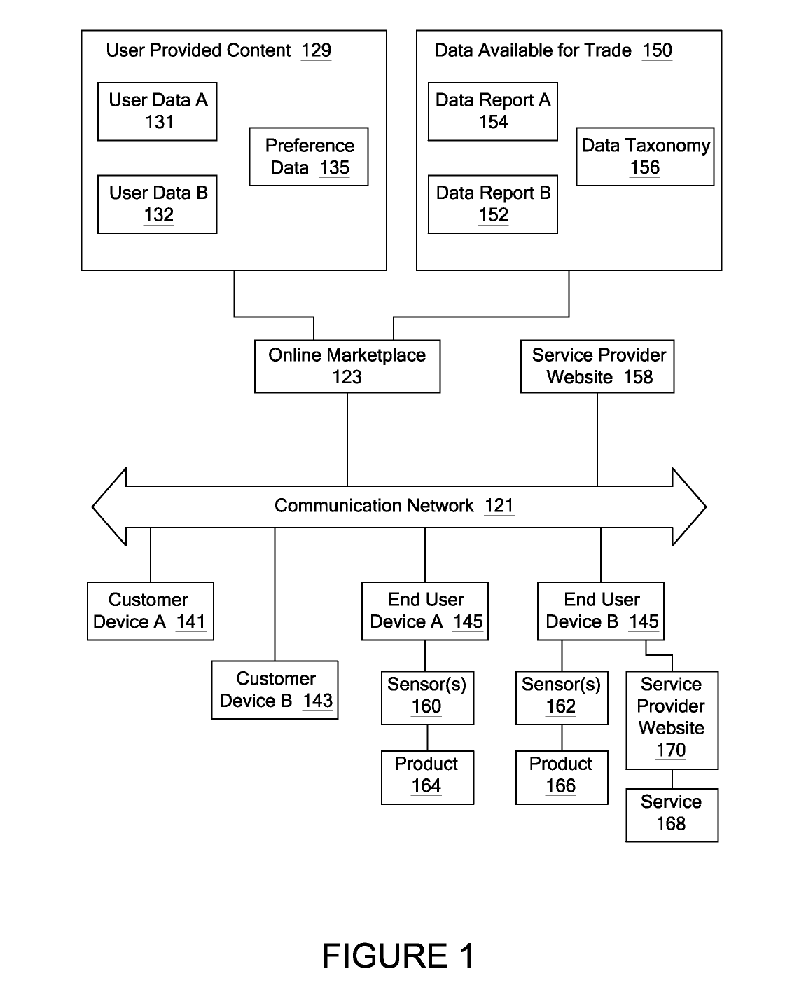

FIG. 1 shows a system to trade data (e.g., user data collected by sensors from end users) using an online marketplace 123 according to one embodiment. In FIG. 1, the end user devices 145 are used to access online marketplace 123 over a communication network 121. The online marketplace 123 may include one or more web servers (or other types of data communication servers) to communicate with the end user devices 145.

The online marketplace 123 is connected to a data storage facility to store user provided content 129, such as user data 131, 132 and end user preference data 135 (e.g., preference data may record customization information regarding an end user's desired or normal interaction with the marketplace 123). Customers access the marketplace 123 using customer devices 141, 143.

In one embodiment, customers and end users must go through a registration process to access and use marketplace 123. For example, an end user agreement may be presented to an end user, and consent to the agreement from the end user required prior to the end user being granted access to marketplace 123.

In one embodiment, the user preference data 135 is configurable, pluggable, and tunable by the user. For example, the user may select a set of criteria from a set of pre-defined criteria, or add a custom designed criterion, or adjust the parameters of the selected criteria. Thus, the users can configure the user data collection and/or uploading process as desired by a particular user.

In one embodiment, the user device 145 may be used to create user data in the form of still or video images of a product usage, which may be tagged with location data from the device. For example, in one embodiment, the user device includes a digital still picture camera, or a digital video camera. In such an embodiment, such images can be tagged with navigation data in an automated way.

Although FIG. 1 illustrates an example system implemented in client server architecture, embodiments of the disclosure can be implemented in various alternative architectures. For example, the online marketplace may be implemented via a peer to peer network of client devices.

In some embodiments, a combination of client server architecture and peer to peer architecture can be used, in which one or more centralized server may be used to provide some of the information and/or services and the peer to peer network is used to provide other information and/or services. Thus, embodiments of the disclosure are not limited to a particular architecture.

In one embodiment, online marketplace 123 may access user data on a service provider website 158 using communication network 121. This user data may be data from invoices or other records that reflect the use by the end user of a service provided, hosted or monitored by or from website 158.

More specifically, online marketplace 123 communicates with end user devices 145 (end user device A and end user device B) to permit each respective end user (of typically many end users) to upload user data to marketplace 123. End user device A may be coupled to one or more sensors 160, which are used to collect data sensed from the operation of a product 164 (e.g., a bicycle) by the user of end user device A.

Sensors 162 may be coupled to or integrated into end user device B. Sensors 162 may sense operating characteristics or conditions, or the output, of a product 166 in order to obtain user data. The data collected by sensors 162 is communicated to end user device B, which may then communicate the data to marketplace 123.

Service provider website 170 may be used to provide a service 168 to the user of end user device B (e.g., a cell phone or data service). Data associated with the use of service 168 may be downloaded to or collected by end user device B, and then sent to marketplace 123. This data also may be directly uploaded to online marketplace 123 from website 170.

In other embodiments, user data associated with product or service use by the user (e.g., a consumer) of end user device B may be uploaded directly from other computer systems (e.g., other client devices), cell phones or other mobile devices, and distributed networks. Data from all of these sources may be used to create user data or user profiles associated with a specific identified user, and all such data may be collected and stored by marketplace 123.

User provided content 129 includes user data A and user data B (131, 132) that has been uploaded or otherwise obtained by marketplace 123. User data A is data that has been collected from end user device A, or is otherwise associated with end user device A. Similarly, user data B has been collected from, or is otherwise associated with, end user device B. For example, user data B may be collected by marketplace 123 from service provider website 158, which may provide a service to end user device B. Thus, user data B may be associated with end user device B, although user data B is not collected directly from end user device B. Preference data 135 may be stored to reflect customized preferences of each end user when uploading data to or otherwise using or interacting with marketplace 123.

Online marketplace 123 makes collected data available for trade to one or more customers (also sometimes referred to herein as buyers). Each such customer may use, for example, customer device A or customer device B to access marketplace 123. Data available for trade 150 may include one or more data reports 152 and 154 (data reports A and B). Data reports A and B may be formed by collecting various types of data from various end users. A customer may specify the type of data desired for a data report.

Marketplace 123 may store user data such that it is associated with one or more data categories (e.g., speed, date, and time). These data categories may be structured into a data taxonomy 156, for example, stored at or accessible by marketplace 123. A customer may use an Internet user interface (e.g., a webpage on a website) to select various desired data categories. Marketplace 123 then may offer data reports matching the desired categories for sale to the customer. In one embodiment, the customer may specify the desired data categories in advance of the collection of the user data from users. Marketplace 123 may communicate the desired data categories to end users, who may then authorize collection of such user data for use in preparing the data report for trade. Marketplace 123 may also automatically create the data report by collecting appropriate user data from end users (e.g., as such data collection may have been previously authorized by end users).

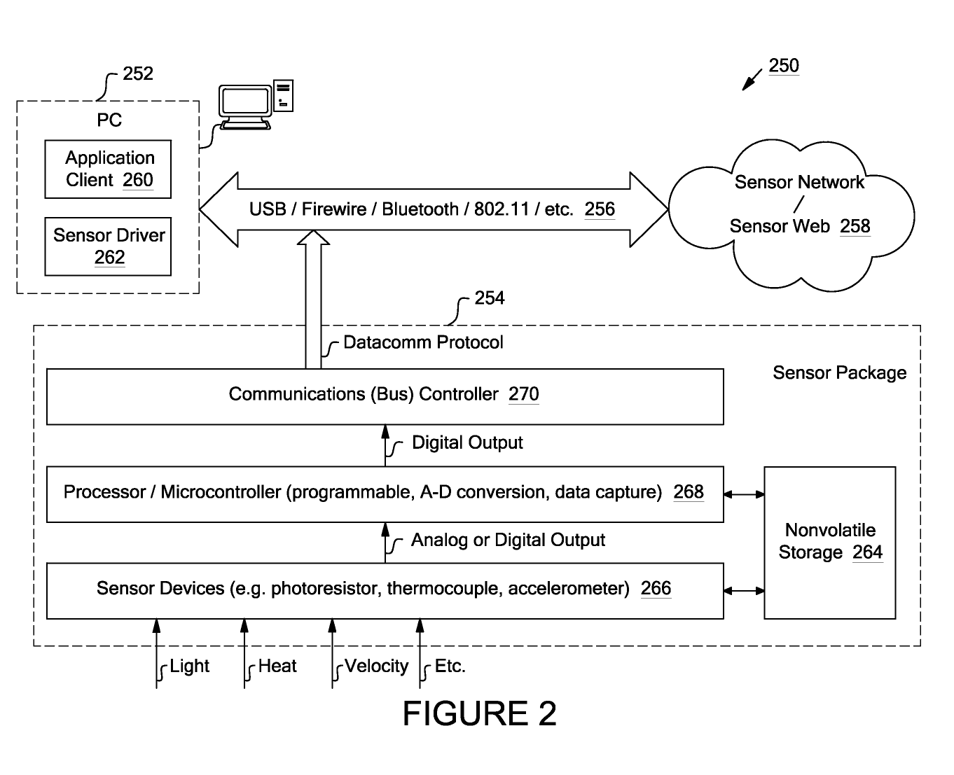

FIG. 2 shows a system 250 for collecting user data using sensors according to one embodiment. System 250 may be used to collect user data using various sensor devices or sensors 266 included in a sensor package 254. Sensors 266 may include, for example, a photoresistor, thermocouple, or accelerometer.

The collected sensor data may be communicated using a communications protocol 256 (e.g., USB, Firewire, Bluetooth, 802.11, RFID, etc.) to an end user device 252. End user device 252 may communicate with marketplace 123 over communication network 121.

An application client 260 and a sensor driver 262 are installed and execute on end user device 252. The collected sensor data may be processed by application client 260 to provide user data for uploading. Communications protocol 256 is further implemented to communicate with a sensor network or sensor web 258 (e.g., which may provide yet further user data to end user device 252, for data collection and eventual uploading to marketplace 123).

Sensor package 254 further includes a microprocessor or microcontroller 268 that controls sensing and/or collection of data by the sensor devices 266. A communications controller 270 couples sensor package 254 to communications protocol 256. Software processes executed by processor 268 for sensing and data collection may be stored on a non-volatile storage device 264.

In one example, data is collected for solar panel usage by a company (i.e., the end user is the company). In this example, data is captured from energy monitors/sensors for solar panel output. The data collection is remote from the solar panel (i.e., the device/product), but data is recorded for the solar panel product performance.

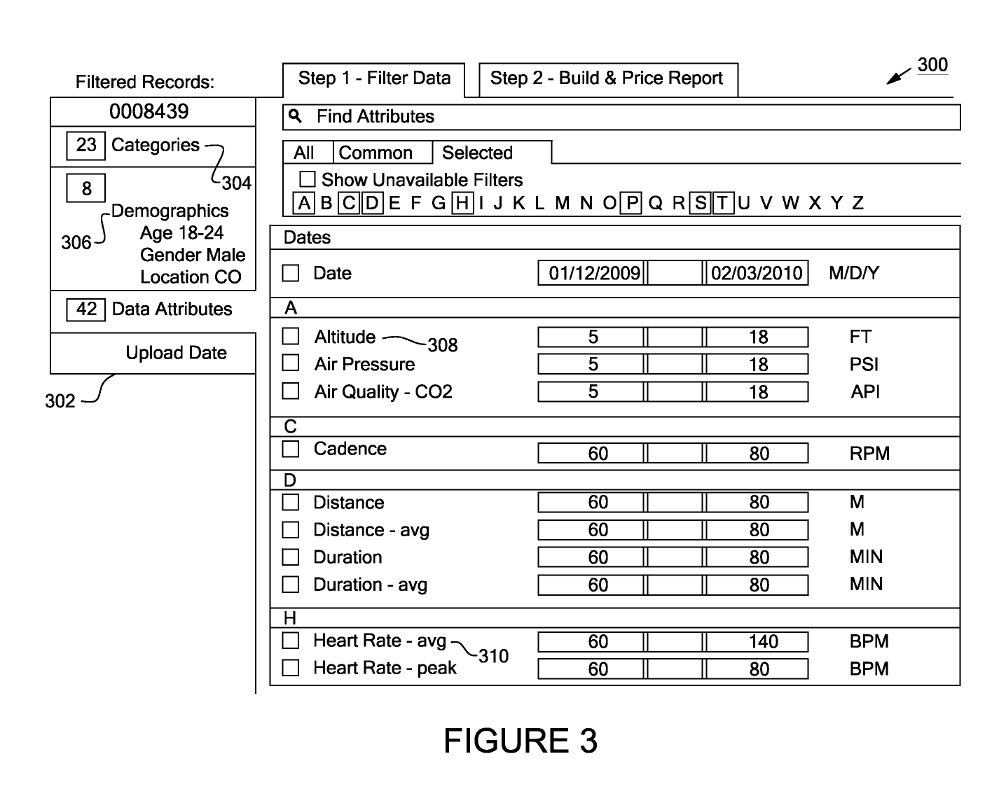

FIG. 3 shows an example of a user interface 300 used by a customer to search for selected user data in online marketplace 123 for potential purchase of a data report or other set of data in a trade transaction according to one embodiment. User interface 300 includes numerous forms of data categories 302 displayed to the customer (e.g., on a display of customer device 141 or 143). These data categories 302 may include demographic categories 306 (e.g., age, gender, or location) and other data categories 304. Examples of data categories 304 include altitude 308 and average heart rate 310 as illustrated in FIG. 3. Other forms of data categories 302 may include upload date, calendar date of product usage, and/or season or time of data collection.

The customer may select particular data categories using menus and/or clicking or activating various listed categories in the user interface. Data reports may then be assembled or located based on the data categories. Data taxonomy 156 may be used as the basis for presenting the categories to the customer.

In one embodiment, after a data report is defined or built based on selected data categories 302, marketplace 123 may determine a price to associate with the data report. The price is offered to the customer as a potential trade. End users receive compensation if a trade is completed based on the extent to which each end user's data is provided or used in the data report. The data report may be provided to a customer as a spreadsheet download including all of the data in the customer's search criteria.

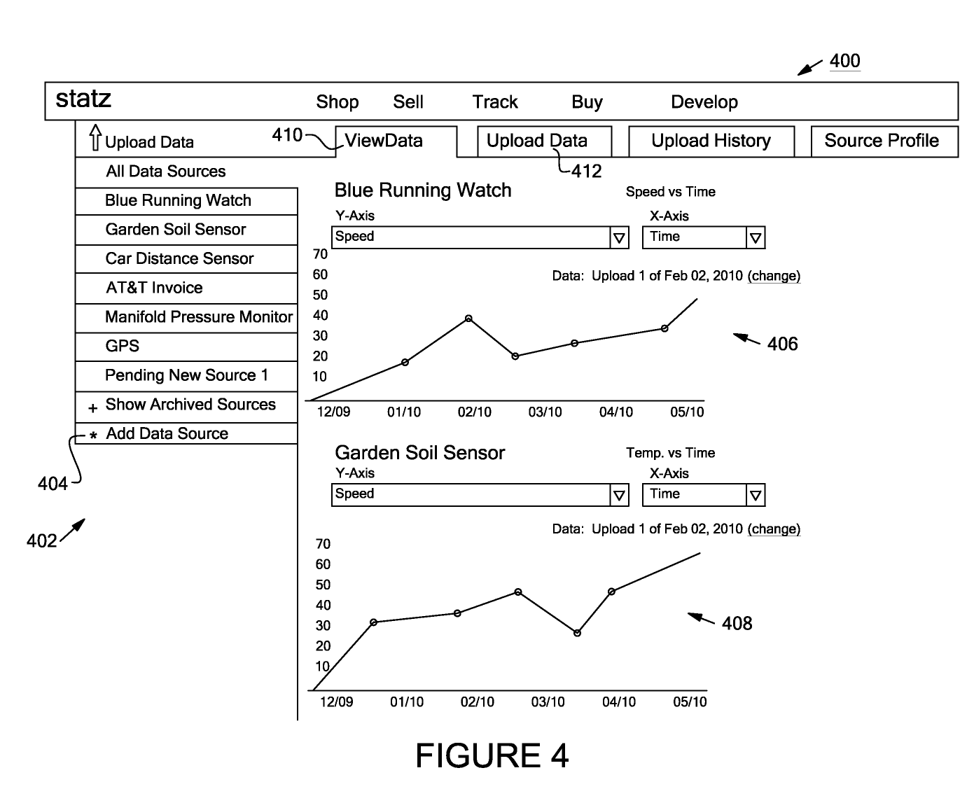

FIG. 4 shows an example of a user interface 400 used by an end user to register data sources (e.g., that provide user data for uploading) and to upload user data to online marketplace 123 according to one embodiment. User interface 400 is used by an end user of an end user device 145 to register data sources 402. For example, a new data source may be registered by clicking on an “Add Data Source” tab or icon 404.

Data sources are sources of data and may include, for example, various products or individual sensors. For example, data sources may include phones and online accounts. Also, data sources may include service provider computer systems or data streams (e.g., service provider website 158 or 170 may be a source of user data). Other data sources may include, for example, non-digital inputs like personal bills, invoices and statements, and other digital inputs from actuators, measurement devices, and cell phone and other software applications.

User data may be uploaded using an “Upload Data” tab 412. Previously uploaded data may be viewed by clicking on a “View Data” tab 410. User data associated with, for example, a “Blue Running Watch” has been uploaded to online marketplace 123 and is presented in graph 406. As another example, user data for a garden soil sensor has been previously uploaded and is presented for viewing to the user in graph 408.

One of the data sources 402 that has been registered by an end user is a source corresponding to a third-party service (indicated as “AT&T Invoice”). This third-party service corresponds to a service provided by service provider website 158 or service provider website 170 in some embodiments. Other examples of collecting data relating to usage by each end user of a third-party service include the usage of one of the following third-party services: website access, utility service, credit card account, bank account, and cell phone operation.

In some embodiments, user data may come from embedded sensors in cars or wireless products. Also, some user data may come from customer invoices, such as cell phone invoices and utility invoices. The marketplace 123 will accept a customer's request for data based on parameters that are selected by the customer.

Available data sets and profiles are searched and a data set is presented for purchase. Algorithms may be used to value the data based on demand and based on value (e.g., how much privacy is associated with a selected data set). The data set is then delivered for revenue, and that revenue may be shared by the marketplace taking fees for handling or brokering the transaction, and another share of revenue going to end users that provided the data.

In one embodiment, an end user car owner has the ability to provide data from the car as a tradable data asset. The marketplace 123 can collect such data down to the individual data set level, allow searches on personal data of car owners, and permit the purchasing of data reports built in real-time from different building block data sets from different people based on search criteria specified by a customer.

In another embodiment, a sensor is placed in a bicycle to link specific consumer behavior to a specific product (i.e., the bicycle). The odometer of the bicycle uses wireless sensors. The marketplace 123 may be used, for example, to link the type of bicycle, the model of bicycle, the tire models, with the distance ridden and how the bicycle is being ridden. Data may be collected as user data and thus provide data related to the type of fatigue and use index currently used by the auto industry so that it is available for bike manufacturers. Such data could also be made available to bicycle repair shops and bicycle designers.

In one embodiment, a customer would go through a data taxonomy of available information selecting bicycle performance and human performance data categories. The customer could further select a data report to be based on age, date, etc. There may be a certain number of end users that match to those characteristics.

Marketplace 123 would then provide for a specified payment for that data report, and deliver the data in a series of different formats as may have been selected by a customer. The revenue from the customer would be distributed to each of the end users that have contributed data to that sample.

In one embodiment, marketplace 123 may identify value patterns where certain types of data are in higher demand. These trends may be identified within the demand profile created by the trading. For example, for the data taxonomy of a bicycle with heart rate, heart rate may be a high-demand data set, but the notion of how fast a user is pedaling may not have as high of a demand.

In another embodiment, marketplace 123 may create personal profiles as tradable assets for individuals on the Internet. Marketplace 123 may create a data taxonomy around behavior, provide granularity in terms of specific data of product and usage, assign a value to each of the data points, and allow those data points individually and in aggregate to be traded for value. In one embodiment, marketplace 123 may provide a compensation system that provides a full circuit of establishing an asset, providing a tradable platform, allowing buyers to select discretely certain aspects of those data sets, packaging those data sets into a security that is traded, and then compensating each of the constituent individual end users at a price or compensation rate that each end user has previously defined based on the end user's desired level of privacy.

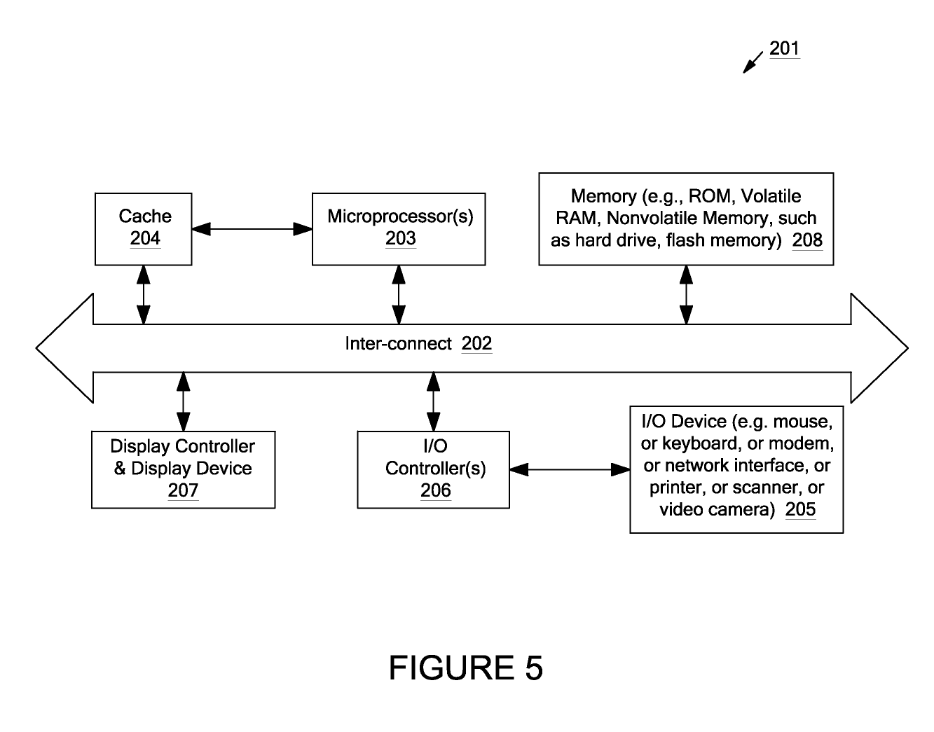

FIG. 5 shows a block diagram of a data processing system which can be used in various embodiments (e.g., to implement online marketplace 123 or service provider website 158 or 170). While FIG. 5 illustrates various components of a computer system, it is not intended to represent any particular architecture or manner of interconnecting the components. Other systems that have fewer or more components may also be used.

In FIG. 5, the system 201 includes an inter-connect 202 (e.g., bus and system core logic), which interconnects a microprocessor(s) 203 and memory 208. The microprocessor 203 is coupled to cache memory 204 in the example of FIG. 5.

The inter-connect 202 interconnects the microprocessor(s) 203 and the memory 208 together and also interconnects them to a display controller and display device 207 and to peripheral devices such as input/output (I/O) devices 205 through an input/output controller(s) 206. Typical I/O devices include mice, keyboards, modems, network interfaces, printers, scanners, video cameras and other devices which are well known in the art.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

The memory 208 may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 5 is used to implement an online website and/or other servers. In one embodiment, a data processing system as illustrated in FIG. 5 is used to implement an end user device (e.g., end user device 145) or a customer device (e.g., customer device 141 or 143). A user device may be in the form of a personal digital assistant (PDA), a client mobile device, a cellular phone, a notebook computer or a personal desktop computer.

In some embodiments, one or more servers of the system can be replaced with the service of a peer to peer network of a plurality of data processing systems, or a network of distributed computing systems, or a network cloud. The peer to peer network, distributed computing system, or cloud, can be collectively viewed as a server data processing system.

Embodiments of the disclosure can be implemented via the microprocessor(s) 203 and/or the memory 208. For example, the functionalities described can be partially implemented via hardware logic in the microprocessor(s) 203 and partially using the instructions stored in the memory 208. Some embodiments are implemented using the microprocessor(s) 203 without additional instructions stored in the memory 208. Some embodiments are implemented using the instructions stored in the memory 208 for execution by one or more general purpose microprocessor(s) 203. Thus, the disclosure is not limited to a specific configuration of hardware and/or software.

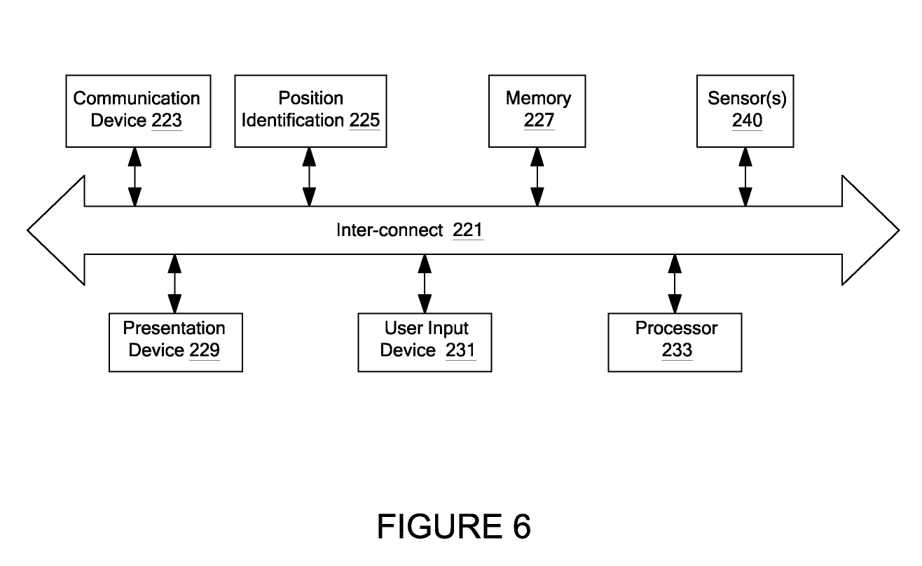

FIG. 6 shows a block diagram of a user device according to one embodiment. In FIG. 6, the user device includes an inter-connect 221 connecting the presentation device 229, user input device 231, a processor 233, a memory 227, a position identification unit 225, a communication device 223, and one or more sensors 240 (e.g., used to collect the user data discussed above). Sensors 240 may alternatively be located in a separate sensing platform or device that communicates (e.g., wirelessly) with the user device. The user device may be used to implement customer device 141, 143 and/or end user device 145.

In FIG. 6, the position identification unit 225 is used to identify a geographic location for associated collected user data with a location. The position identification unit 225 may include a satellite positioning system receiver, such as a Global Positioning System (GPS) receiver, to automatically identify the current position of the user device. Alternatively, an interactive map can be displayed to the user; and the user can manually select a location from the displayed map.

In FIG. 6, the communication device 223 is configured to communicate with an online marketplace to provide user data. In one embodiment, the user input device 231 is configured to generate user data which is to be tagged with the navigation information. The user input device 231 may include a text input device, a still image camera, a video camera, and/or a sound recorder, etc. In one embodiment, the user input device 231 and the position identification unit 225 are configured to automatically tag the user data collected with the navigation information identified by the position identification unit 225.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using an Application-Specific Integrated Circuit (ASIC) or a Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Additional other embodiments may include the following methods, machine readable mediums, and systems (numbered below merely for ease of reference). In embodiment number 1 below, a trading system is used to sell data (collected from end users or sellers) selected by a customer (or buyer) from various data categories in a data taxonomy presented to the buyer in a data trading marketplace. The marketplace may be implemented using a data processing system as described herein. The data traded on the marketplace may be sets of data (e.g., data reports or other data sets).
1. A method, comprising:
   receiving, via a data processing system, a plurality of data sets from a plurality of sellers, each set corresponding to a respective one of the sellers;
   providing, via the data processing system, access to a data taxonomy for a plurality of buyers, the taxonomy including a plurality of data categories each corresponding to data available in one or more of the data sets;
   receiving, via the data processing system, a request from a first buyer of the plurality of buyers, the request specifying at least one selected category of the plurality of data categories;
   presenting, via the data processing system, a first data set of the plurality of data sets to the first buyer for purchase, the first data set comprising data corresponding to the at least one selected category; and
   providing, via the data processing system, the first data set to the first buyer in exchange for compensation from the first buyer.
2. The method of embodiment 1, wherein the data processing system hosts a website configured to accept electronic orders from one or more of the plurality of buyers for the purchase of one or more of the plurality of data sets.
3. The method of embodiment 1, wherein the plurality of sellers comprises a plurality of persons.
4. The method of embodiment 1, wherein the first data set is provided from a first seller of the plurality of sellers, and the first data set comprises data collected by at least one sensor monitoring a product of the first seller.
5. The method of embodiment 4, wherein the at least one sensor is embedded in or mounted to the product and is configured to automatically send the collected data to the data processing system.
6. The method of embodiment 4, further comprising receiving from the first seller, via the data processing system, a selection of one of a plurality of levels of data privacy presented to the first seller for collection of data from the first seller.
7. The method of embodiment 5, wherein the first seller is a person and the product is an end-user product located in a residence of the first seller.
8. The method of embodiment 5, wherein the product is a user device comprising a position identification unit to provide location data and a communication device, the method further comprising receiving, from the communication device, the location data.
9. The method of embodiment 8, wherein the first data set includes the location data.
10. The method of embodiment 4, further comprising receiving from the first seller, via the data processing system prior to receiving the first data set, an identification of the product.
11. The method of embodiment 1, wherein the first data set corresponds to data for two or more sellers of the plurality of sellers, and further comprising:
   receiving, via the data processing system, sales revenue as the compensation from the first buyer for the first data set; and
   providing, via the data processing system, a respective share of the sales revenue to each of the two or more sellers.
12. The method of embodiment 1, wherein the first data set corresponds to a first seller of the plurality of sellers, and further comprising receiving from the first seller one or more of the plurality of data categories that correspond to data provided from the first seller in the first data set.
13. The method of embodiment 1, wherein the plurality of data categories includes one or more categories selected from the following: personal characteristics of a person, and behavioral characteristics of a person.
14. The method of embodiment 1, further comprising assigning a respective price to each of the plurality of data sets, and presenting, via the data processing system, each respective price to the plurality of buyers.
15. The method of embodiment 14, further comprising:
   monitoring a series of sales transactions of data sets with the plurality of buyers; and
   identifying value patterns from the monitoring;
   wherein assigning each respective price is based at least in part on the identified value patterns.
16. The method of embodiment 1, wherein the first data set is a continuing stream of data, and further comprising periodically sending, via the data processing system, a portion of the stream of data to the first buyer.
17. The method of embodiment 1, wherein each of the plurality of data sets includes data collected from a communication device of a user device, the data from the communication device identifying a time associated with collection of the data and a form of communication associated with collection of the data.
18. The method of embodiment 17, wherein the form of communication is one of voice communication and text communication.
19. A machine readable medium embodying instructions, the instructions causing a data processing system to perform a method, the method comprising:
   receiving, via a data processing system, a plurality of data sets from a plurality of sellers, each set corresponding to a respective one of the sellers;
   providing, via the data processing system, access to a data taxonomy for a plurality of buyers, the taxonomy including a plurality of data categories each corresponding to data available in one or more of the data sets;
   receiving, via the data processing system, a request from a first buyer of the plurality of buyers, the request specifying at least one selected category of the plurality of data categories;
   presenting, via the data processing system, a first data set of the plurality of data sets to the first buyer for purchase, the first data set comprising data corresponding to the at least one selected category; and
   providing, via the data processing system, the first data set to the first buyer in exchange for compensation from the first buyer.
20. A data processing system, comprising:
   memory to store a plurality of data sets corresponding to a plurality of sellers; and at least one processor configured to:
      receive the plurality of data sets from the plurality of sellers, each set corresponding to a respective one of the sellers,
      provide access to a data taxonomy for a plurality of buyers, the taxonomy including a plurality of data categories each corresponding to data available in one or more of the data sets,
      receive a request from a first buyer of the plurality of buyers, the request specifying at least one selected category of the plurality of data categories,
      present a first data set of the plurality of data sets to the first buyer for purchase, the first data set comprising data corresponding to the at least one selected category, and
      provide the first data set to the first buyer in exchange for compensation from the first buyer.
21. A method, comprising:
   hosting, via at least one web server, a marketplace for trading of data provided from a plurality of end users;
   collecting respective user data from each respective end user of the plurality of end users, the respective user data comprising data obtained from use by the respective end user of at least one of a product and a service;
   storing the respective user data for each respective end user;
   offering, via the marketplace, the respective user data of each respective end user for a trade with a first customer;
   if the first customer accepts the trade, providing the respective user data of a first end user to the first customer; and
   providing compensation to the first end user based on a share of the revenue received for the trade;
   wherein the collecting respective user data comprises associating a time of receipt at the at least one web server with the respective user data.
22. The method of embodiment 21, further comprising:
   collecting data relating to usage by each respective end user of a third-party service;
   creating an aggregated index associated with product or service usage based on the respective user data of each respective end user; and
   offering the index, via the marketplace, for a trade with one or more customers.
23. The method of embodiment 21, wherein:
   the respective user data of the first end user comprises data collected by at least one sensor monitoring a product used by the first end user; and
   the at least one sensor includes an environmental sensor.
24. The method of embodiment 21, wherein:
   the respective user data of the first end user comprises data collected by at least one sensor monitoring a product used by the first end user; and
   the at least sensor is configured for wireless communication of user data.
25. The method of embodiment 21, further comprising:
   assigning a price to a set of user data collected from end users, and presenting the price to customers visiting the marketplace when offering the user data for trade;
   monitoring a plurality of transactions corresponding to a plurality of trades of user data with customers; and
   identifying pricing patterns from the monitoring;
   wherein assigning the price is based at least in part on the identified pricing patterns.
26. The method of embodiment 21, further comprising:
   presenting to each respective end user a plurality of levels of data privacy; and
   receiving from each respective end user a selection from the plurality of levels of data privacy for use in collection of data from the respective end user.
27. The method of embodiment 21, further comprising receiving an affirmative selection from one of the plurality of end users permitting the marketplace to trade personally identifiable data with customers.
28. The method of embodiment 21, wherein the respective user data comprises data obtained from use by the respective end user of the product, the method further comprising:
   receiving an identification of the product from the respective end user prior to the collecting of the respective user data;
   associating the identification of the product with an entity associated with manufacture, development, or design of the product; and
   providing compensation to the entity based on a share of revenue received from a customer for user data obtained from the use by the respective end user of the product.
29. The method of embodiment 21, wherein each respective end user of the plurality of end users receives information indicating that an end user of the marketplace retains ownership of user data.
30. The method of embodiment 21, further comprising handling the trade with the first customer as one of an auction, a barter, or an exchange.
31. The method of embodiment 21, further comprising providing, via the marketplace, a user interface to each respective end user of the plurality of end users, the user interface configured to present to each respective end user a registration page to register a plurality of data sources corresponding to user data to be provided from the respective end user.
32. The method of embodiment 31, wherein the plurality of data sources comprises at least two of a sensor, a personal mobile device, a mobile phone, a laptop computer, a desktop computer, a camera, a vehicle, a garden pH meter, a blood-pressure monitor, a weather station, and an online account for a service provided by a third party to the respective end user.
33. The method of embodiment 31, wherein the user interface is configured to further present a page to display compensation earned by each respective end user from trading of data reports in the marketplace.

Although some of the drawings discussed above illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
hosting, via at least one web server, a marketplace for trading of data provided from a plurality of end users;
collecting respective user data from each respective end user of the plurality of end users, the respective user data comprising data obtained from use by the respective end user of at least one of a product and a service;
storing the respective user data for each respective end user;
offering, via the marketplace, the respective user data of each respective end user for a trade with a first customer;
if the first customer accepts the trade, providing the respective user data of a first end user to the first customer; and
providing compensation to the first end user based on a share of the revenue received for the trade.

2. The method of claim 1, wherein the respective user data comprises data obtained from use by the respective end user of the product, the method further comprising:
receiving an identification of the product from the respective end user prior to the collecting of the respective user data; and
associating the respective user data with the identification of the product.

3. The method of claim 2, further comprising associating the respective user data with data regarding behavior of the respective end user.

4. The method of claim 2, wherein the product is a user device comprising a position identification unit to provide location data and a communication device, the method further comprising:
receiving, from the communication device, the location data; and
further associating the respective user data with the location data.

5. The method of claim 1, further comprising collecting data relating to usage by each respective end user of a third-party service.

6. The method of claim 5, wherein the usage of the third-party service is at least one of the following: website usage, utility service usage, credit card usage, bank account usage, and cell phone usage.

7. The method of claim 1, further comprising:
collecting data regarding the respective end user from a plurality of third-party websites; and
associating the data from the plurality of third-party websites with the respective user data.

8. The method of claim 1, wherein the respective user data comprises data obtained from use by the first end user of the product, the method further comprising:
receiving an identification of the product from the first end user;
associating the respective user data of the first end user with the product;
collecting data relating to usage by the first end user of a third-party service for the product; and
further associating respective user data of the first end user with the data relating to usage of the third-party service.

9. The method of claim 1, wherein the respective user data of the first end user comprises data collected by at least one sensor monitoring a product used by the first end user.

10. The method of claim 1, further comprising providing access to a data taxonomy for customers of the marketplace, the taxonomy including a plurality of categories corresponding to user data obtained from end users, wherein the user data is available for purchase through the marketplace.

11. The method of claim 10, wherein the plurality of categories includes at least one of personal characteristics of a person and behavioral characteristics of a person.

12. The method of claim 1, further comprising assigning a price to a set of user data collected from end users, and presenting the price to customers visiting the marketplace when offering the user data for trade.

13. The method of claim 1, further comprising receiving a definition of a data level from each respective end user, the data level defining the forms of data for collection from the respective end user.

14. The method of claim 1, further comprising providing, via the marketplace, a user interface to a plurality of customers, the user interface configured to present to each respective customer of the plurality of customers the following: a plurality of data categories for selection by the respective customer, and a menu of demographic categories for selection by the respective customer.

15. The method of claim 14, further comprising, after the selection by the respective customer of at least one of the data categories and of at least one of the demographic categories, providing, via the marketplace, a price for a data report for purchase by the customer.

16. The method of claim 15, wherein the data report includes the respective user data of the first end user, and the method further comprising receiving the revenue for the trade from the customer in exchange for the data report.

17. The method of claim 15, further comprising providing the data report to the customer in the form of a plurality of periodic reports sent over time, and receiving the revenue in the form of a series of payments from the customer, each of the series of payments corresponding to one of the periodic reports.

18. The method of claim 15, further comprising providing the data report to the customer, wherein the data report includes user data from each of the plurality of end users.

19. A machine readable medium embodying instructions, the instructions causing a data processing system to perform a method, the method comprising:
hosting, via the data processing system, a marketplace for trading of data provided from a plurality of end users;
collecting respective user data from each respective end user of the plurality of end users, the respective user data comprising data obtained from use by the respective end user of at least one of a product and a service;
storing the respective user data for each respective end user;
offering, via the marketplace, the respective user data of each respective end user for a trade with a first customer;
if the first customer accepts the trade, providing the respective user data of a first end user to the first customer; and
providing compensation to the first end user based on a share of the revenue received for the trade.

20. A data processing system, comprising:
memory to store user data for a plurality of end users; and
at least one processor configured to:
host a marketplace for trading of data provided from the plurality of end users;
collect respective user data from each respective end user of the plurality of end users, the respective user data comprising data obtained from use by the respective end user of at least one of a product and a service;
offer the respective user data of each respective end user for a trade with a first customer;
if the first customer accepts the trade, provide the respective user data of a first end user to the first customer; and
provide compensation to the first end user based on a share of the revenue received for the trade.
